(19) United States
(12) Patent Application Publication
(10) Pub. No.: US 2006/0278783 A1
(43) Pub. Date: Dec. 14, 2006

(54) Clamp

(75) Inventor: Laurence Rubin, Newark, NJ (US)

Correspondence Address: KATTEN MUCHIN ROSENMAN LLP, 575 MADISON AVENUE, NEW YORK, NY, 10022-2585, US

(73) Assignee: Testrite Instruments Co., Inc.

(21) Appl. No.: 11/437,086

(22) Filed: May 19, 2006

Related U.S. Application Data
(60) Provisional application No. 60/685,262, filed on May 26, 2005.

(51) Int. Cl. G09F 7/18

(52) U.S. Cl. 248/230.1

(57) ABSTRACT

A clamp for maintaining a stationary position on a pole includes clamp portions that area engageable with each other to surround the periphery of a pole. A positioning device disposed in one of the clamp portions and simultaneously compresses against periphery of the pole and tensions one of the engaged clamp portions against the periphery of the pole to maintain the clamp in the stationary position on the pole. A system for visual merchandising is also disclosed.

### CROSS-REFERENCE TO RELATED APPLICATIONS

This application is a non-provisional counterpart to and claims priority to U.S. Ser. No. 60/685,262 filed on May 26, 2005, and which is hereby incorporated by reference in its entirety for all purposes.

### FIELD OF THE INVENTION

The present invention relates to visual merchandising systems, more particularly, to clamps used with poles in visual merchandising systems.

### BACKGROUND OF THE INVENTION

Visual merchandising systems attract the attention of potential customers by displaying a merchant's products in an eye-catching manner and presenting selected useful information about those products and/or the merchant.

While able to be used in any circumstance, visual merchandising systems are typically used by exhibitors at tradeshows for a relatively limited period and in-store fixture settings where display and use requirements are often changing. Consequently, users look for systems and accompanying system components that accentuate features that make travel and display easier. Thus, it is preferred that systems and system components are easily assemblelable, then easily broken down, while also being durable and strong.

A further feature that is typically important is that systems are flexible in adding display components, such as signs or trays, to main components, such as poles,.so as to customize the available display space. Typically, visual merchandising systems comprise a pole, which is freestanding or tensioned against floor and ceiling. On the pole, attachments are positioned using any type of suitable connection device that maintains the relative position of the attachment with the pole.

Such devices have generally been the weak feature of the system for a number of reasons. The devices are attached to tubular poles having smooth surfaces. Consequently, poles provide little or no gripping aid to the connection devices. At the same time, the devices must support cantilevered attachments that may exert large overturning moments because of the heavy product load the attachments carry.

Additionally many devices suffer from inherent problems such as being difficult to place by one user and being difficult to reposition or remove. Other devices suffer from inherent problems wherein parts wear out. For example, devices that rely on spring tensioning tend to grow weaker over time as the spring becomes worn out.

Thus, what is needed is a device that easily placed, readily repositionable, and removed and that is durable.

### SUMMARY OF THE INVENTION

The present invention is directed to a visual merchandising system and a connection device configured in one or more embodiments as a clamp attached to or biased against the pole. The clamp is held positionally by at least frictional engagement against the pole.

The clamp has at least a first and a second clamp portion joined to each other using dove-tailed joints. In one or more embodiments, each clamp portion is configured to have a mortise at one end and a tenon at another end. At least on clamp portion comprises a securing means for attaching or biasing the assembled clamp portion to the pole

The clamp comprises a plurality of exterior channels wherein attachments may be removably attached to or biased to the clamp.

### BRIEF DESCRIPTION OF THE DRAWING

FIG. 1 is an elevational view of a visual merchandising system in accordance with one or more embodiments of the present invention.

FIG. 2 an isometric view of one embodiment of the clamp in accordance with one or more embodiments of the present invention in an open position, wherein the first and second clamp portions are unaligned.

FIG. 3 is an isometric view of the clamp in accordance with one or more embodiments of the present invention in a closed position, wherein the first and second clamp portions are aligned.

FIG. 4a is a planar view of a clamp portion in accordance with one or more embodiments of the present invention.

FIG. 4b is an elevational view of the first type of clamp portion in accordance with one or more embodiments of the present invention.

FIG. 4c is a planar view of a clamp comprising the first type of clamp portion in accordance with one or more embodiments of the present invention.

FIG. 5a is a planar view of a second type of clamp portion in accordance with one or more embodiments of the present invention.

FIG. 5b is an elevational view of the second type of clamp portion in accordance with one or more embodiments of the present invention.

FIG. 5c is a planar view of a clamp comprising the first and second types of clamp portions in accordance with one or more embodiments of the present invention.

FIG. 5d is a planar view of a clamp comprising the second type of clamp portions in accordance with one or more embodiments of the present invention.

FIG. 6a is a planar view of a third type of clamp portion in accordance with one or more embodiments of the present invention.

FIG. 6b is an elevational view of the third type of clamp portion in accordance with one or more embodiments of the present invention.

FIG. 6c is a planar view of a clamp comprising the first and third types of clamp portions in accordance with one or more embodiments of the present invention.

FIG. 7a is an elevational view of an attachment in accordance with one or more embodiments of the present invention.

FIG. 7b is a detailed view of a connector and an attachment in accordance with one or more embodiments of the present invention.

FIG. 7c is an elevational view of a further embodiment of an attachment in accordance with one or more embodiments of the present invention.

FIGS. 8a, 8b, and 8c are isometric views of further embodiments of the present invention wherein one or more display units 70 are supported by one or more attachments 60 in accordance with one or more embodiments of the present invention.

### DETAILED DESCRIPTION

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like-referenced characters designate like or similar parts.

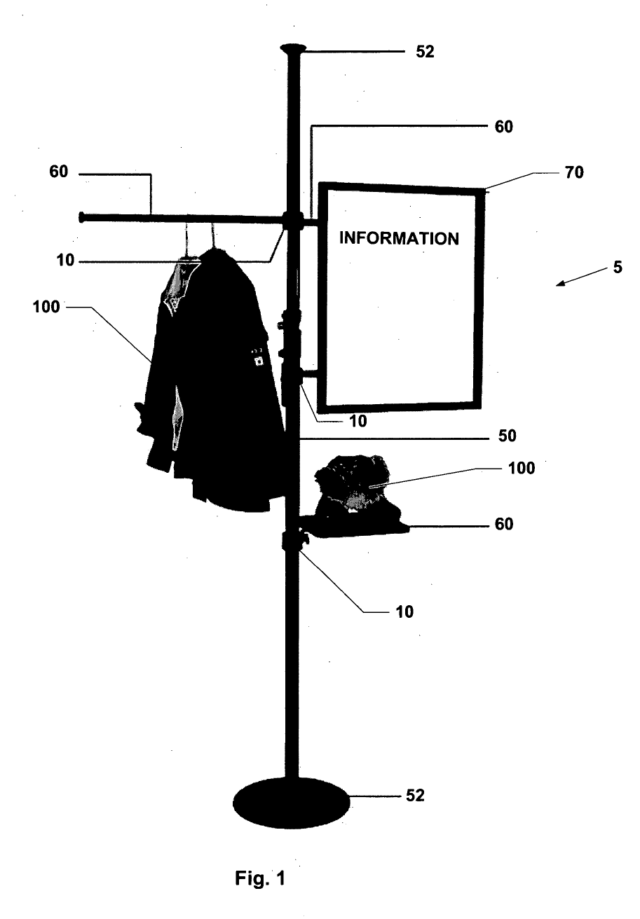

FIG. 1 illustrates a visual merchandising system 5 of the present invention. Therein, a pole 50 is supported by a base 52 and is either freestanding or tensioned against a ceiling using a cap 54 or suction cup to stabilize the pole against the ceiling. Clamps 10 in accordance with the present invention attach to or bias against pole 50 to support one or more attachments 60. Attachments 60 may display merchandise 100 or the like using shelf attachments or arm attachments and or support further display components. Clamps 10 are configured to support by themselves one or more attachments 60 or be adjustable to support, in combination with other clamps 10, one or more attachments 60.

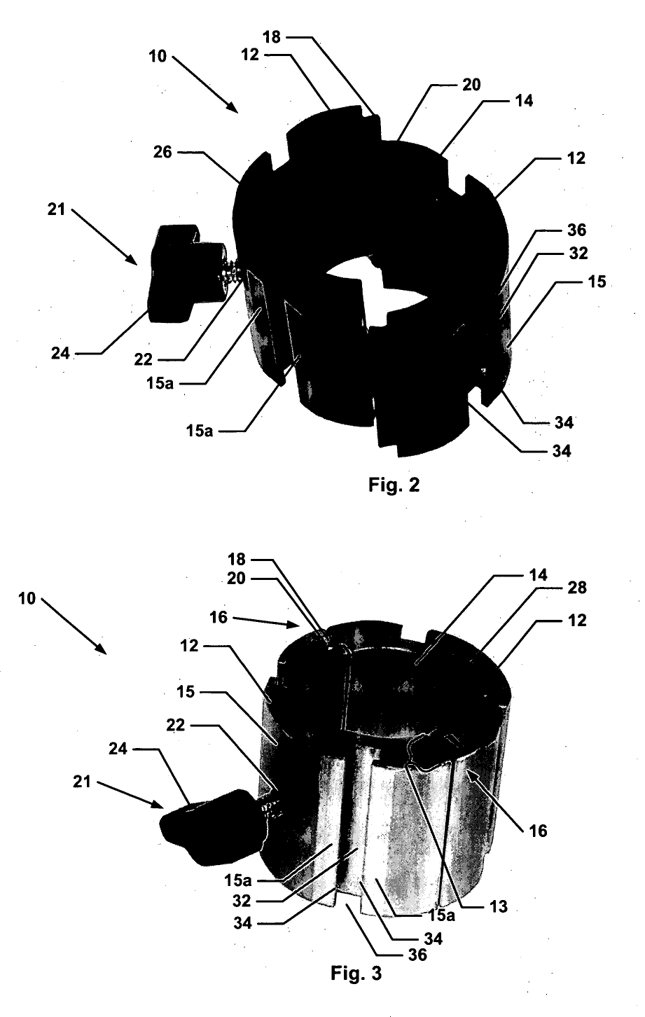

FIGS. 2 and 3 illustrate a clamp 10 of the present invention comprising a plurality of clamp portions 12 that may be joined together using a plurality of dovetailed joints 16 to be secured against a pole 50 of visual merchandising systems 5. Specifically in the embodiment of FIGS. 2 and 3, a pair of clamp portions 12 are capable of being joined together from an open and unaligned position, FIG. 2, to a closed and aligned position, FIG. 3, as will be described further herein, using a pair dovetail joints 16.

Each clamp portion 12 has an approximate semi-circular shape having a substantially smooth inner surface 14 oriented to the “interior” of clamp 10 and an outer surface 15 oriented to the “exterior” of clamp 10. Inner surface 14 has at least a portion having a radius larger than or equal to the exterior radius of pole 50 and outer surface 15 has an interrupted surface that has a radius that is at least greater than the exterior radius of pole 50 by the thickness 13 of clamp 10, e.g. camp portions 12.

Clamp portions 12 may be made of metal, plastic, or suitable material, be painted or protected to maintain appearance for repeated usage, and be manufactured for reasons of economy identically. Even when manufactured identically, the two clamp portions may differ. Thus, one clamp portion 12 may comprise a securing means 21, described below, while the other does not.

Each clamp portion 12 includes at one arcuate end of a tenon 18 and at the other arcuate end a mortise 20. To form clamp 10 clamp portions 12 are oriented so that the tenon of one clamp portion is opposed to the mortise of the other clamp portion and vice versa. In turn, the tenon and mortise of each clamp portion are configured to mate with the respective tenon or mortise to form a pair of dovetail joints 16. Advantageously, dovetail joint 16 resists radial displacement of one clamp portion relative to another but permits axial displacement of one clamp portion to another. In one embodiment, one clamp portion 12 is disposed with tenons 18 at each arcuate end and a mating clamp portion is disposed with mortises 20 at each arcuate end.

One or both of the clamp portions 12 may include a securing means 21. In one embodiment the securing means is configured as a thumbscrew 24 received in a threaded opening 22 that advances a pad 26, made from rubber, plastic, or the like which is preferably non-marring and non-marking against pole 50 to bear against the opposing clamp portion 12.

Once pole 50 has been placed near a desired location and secured for example by extending it such a length that it is under compression from both the floor and ceiling, clamp 10 may be attempted to be secured to pole 50 so that further units of the visual merchandising systems may be properly used. The user working alone or in cooperation with others places a first clamp portion 12 against pole 50 and holds it near a desired axial position of pole 50.

This first clamp portion may be configured to include securing means 21 or it may be a clamp portion configured not to have a securing means. The user, if working alone, uses his free hand to inspect the second clamp portion to assure that this second clamp portion 12 does indeed include a securing means and that the securing means has been retracted at least sufficiently in pocket 29 as will be described below. The user further confirms that the second clamp portion 12 is oriented in his hand such that when placed against pole 12 the tenon 18 and mortise 20 of the second clamp portion are opposed to the mating mortise and tenon of the first clamp portion.

Subsequently, the user positions the second clamp portion 12 against pole 50 to be substantially radially opposite the first clamp portion 12. Further, the user places the second clamp portion in an axial position that is offset but immediately adjacent to the first clamp portion 12. In other words, as will become apparent, the user will aim to place the second clamp portion 12 radially opposite and immediately above or below the fist clamp portion 12.

The user then rotates and/or slides the first or the second clamp portion 12 so that the tenon and mortise of the clamp portions engage in a dovetail joint 16. Having the joined clamp portions 12 using dovetail joints 16 the portions are now held radially and in general not radially displaceable. Thus, the user may hold the clamp portions in one hand and conveniently position and reposition the clamp 10 until it is in a desired location on the pole. A desired position may be one where the attachments once added to clamp 10 are at the appropriate axial location and circumferential orientation relative to the pole.

Before finally securing clamp 10 to pole 50, the user assures that the clamp portions 12 are preferably substantially aligned in a closed position, as shown in FIG. 3—although, exact alignment is not required. If not, the user slides the clamp portions axially in such a way that the clamp portions are aligned in the closed position. To secure clamp 10 to pole 50, the user turns thumbscrew 24 of the second clamp portion 12. Turning thumbscrew 24 causes pad 26 to advance and, thus, biasing pole 50 against the first clamp portion 12.

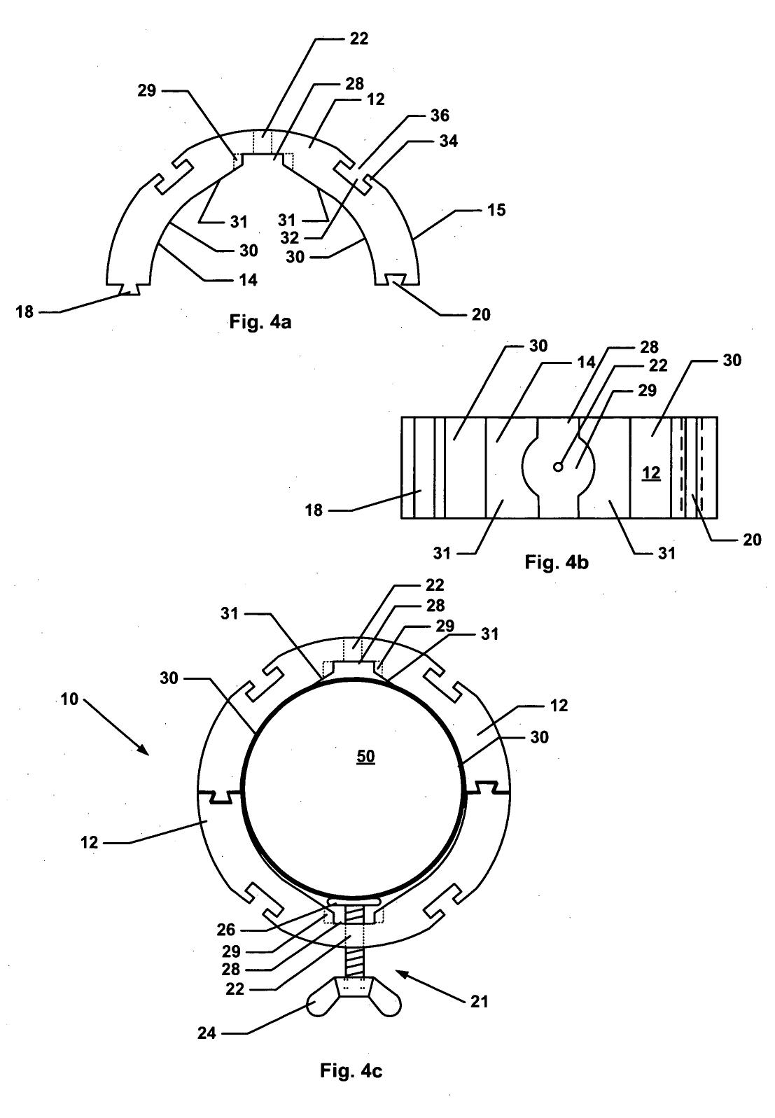

FIGS. 4a and 4b illustrate the interior construction of a first type of clamp portion 12 adapted to comprise securing means 21 in accordance with one or more embodiments the present invention. FIG. 4c is a planar view wherein like clamp portions 12 form clamp 10 in accordance with one or more embodiments of the present invention.

Clamp portion 12 shown in planar view in FIG. 4a includes an inner channel 28. As depicted FIG. 4b, an inner channel 28 is disposed in the clamp portion in a position that is preferably central to clamp portion 12. Inner channel 28 comprises a rear wall and perpendicularly sidewalls to create an axial channel open to the interior of clamp portion 12. A pocket 29 is disposed in the inner channel and is centered with respect to opening 22 wherein a thumbscrew 24 or the like is received at least partially, which operably advances pad 26 through clamp portion 12.

Inner surface 14 comprises a plurality bearing surfaces 30 having a radius approximately similar to the radius of exterior surface of pole 50. Thus, when pad 26 is advanced from pocket 29, it biases pole 50 against at least one or more bearing surfaces 30 of the opposed clamp portion 12. Inner surface 14 is further configured to have a substantially planar surfaces 31 that transition from bearing surfaces 30 to inner channel 28.

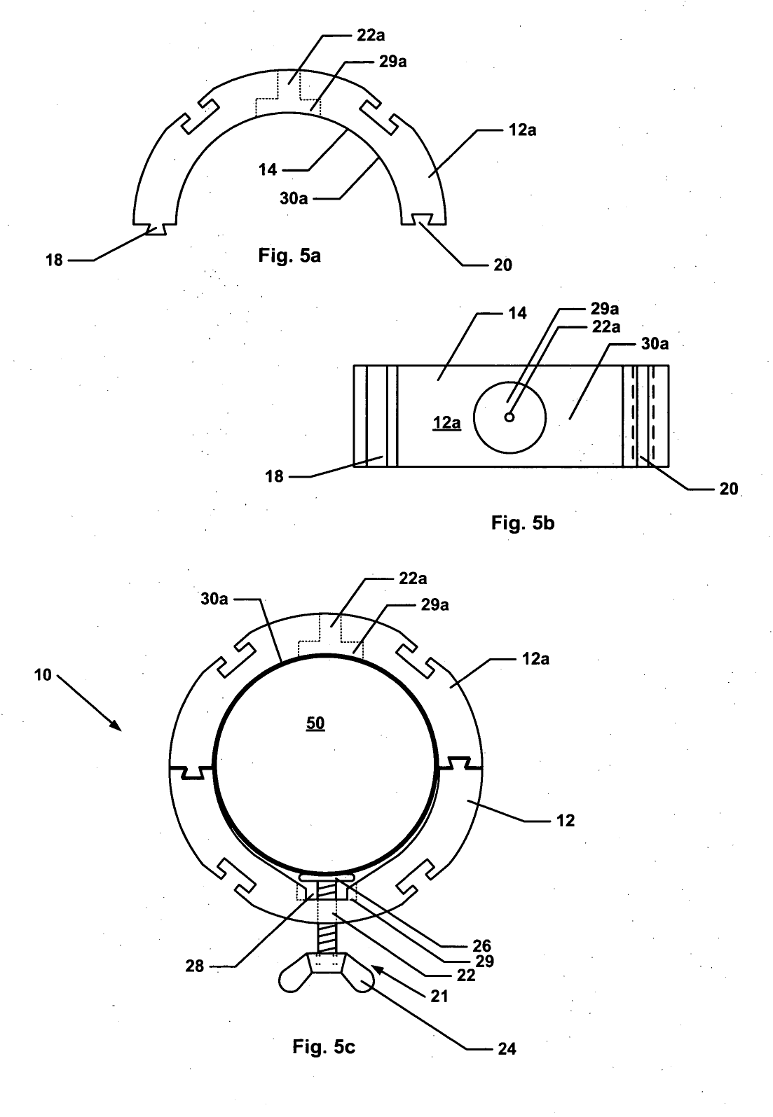

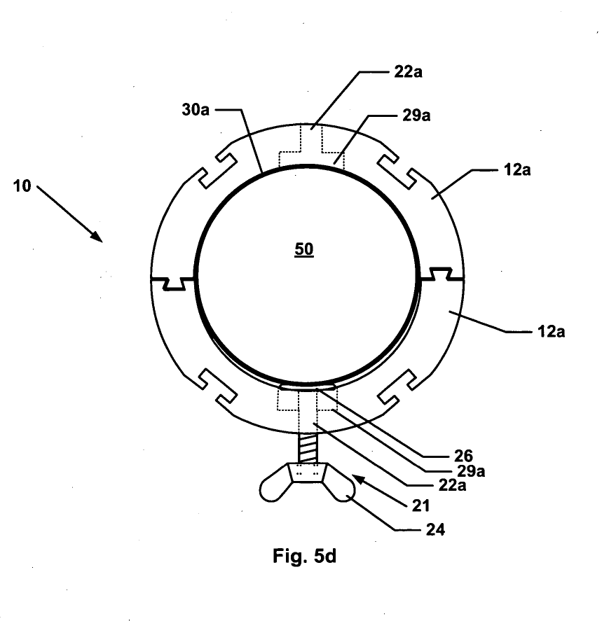

FIGS. 5a and 5b further illustrate the interior construction of a second type of clamp portion 12a in accordance with one or more embodiments the present invention. Therein, inner channel 28 is not used and a pocket 29a is configured directly into inner surface 14. Thus, pocket 29a is centered with respect to an opening 22a and is bordered by inner surface 14, which comprises a continuous bearing surface 30 and is interrupted only by pocket 29a. Thumbscrew 24 or the like is received at least partially in opening 22 and operably advances pad 26 through clamp portion 12.

FIG. 5c is a planar view wherein clamp portions 12 adapted to inner channel 28 and clamp portion 12a without an inner channel 28 form clamp 10 in accordance with one or more embodiments of the present invention. Therein, pole 50 is biased substantially against all of surface 30a.

FIG. 5d is a planar view wherein two clamp portions 12a adapted without an inner channel 28 form clamp 10 in accordance with one or more embodiments of the present invention. Similarly, pole 50 is biased substantially against all of surface 30a.

Regardless of embodiment, pocket 29 preferably accommodates substantially the entire thickness of pad 26. During the initial placement by the user of clamp portion 12 against pole 50, if pad 26 extends beyond inner surface 14, the clamp portion will not fit properly with the mating clamp portion.

In one or more embodiments, however, pole 50 need not be biased against a clamp portion 12 that is configured to accommodate a securing means 21. Consequently, when the clamp portions are not alike, the clamp portion against which pole 50 is biased may be conveniently configured to omit threaded opening 22, channel 28 and pocket 29 and have an uninterrupted smooth inner surface 14 that may comprise entirely a bearing surface 30b.

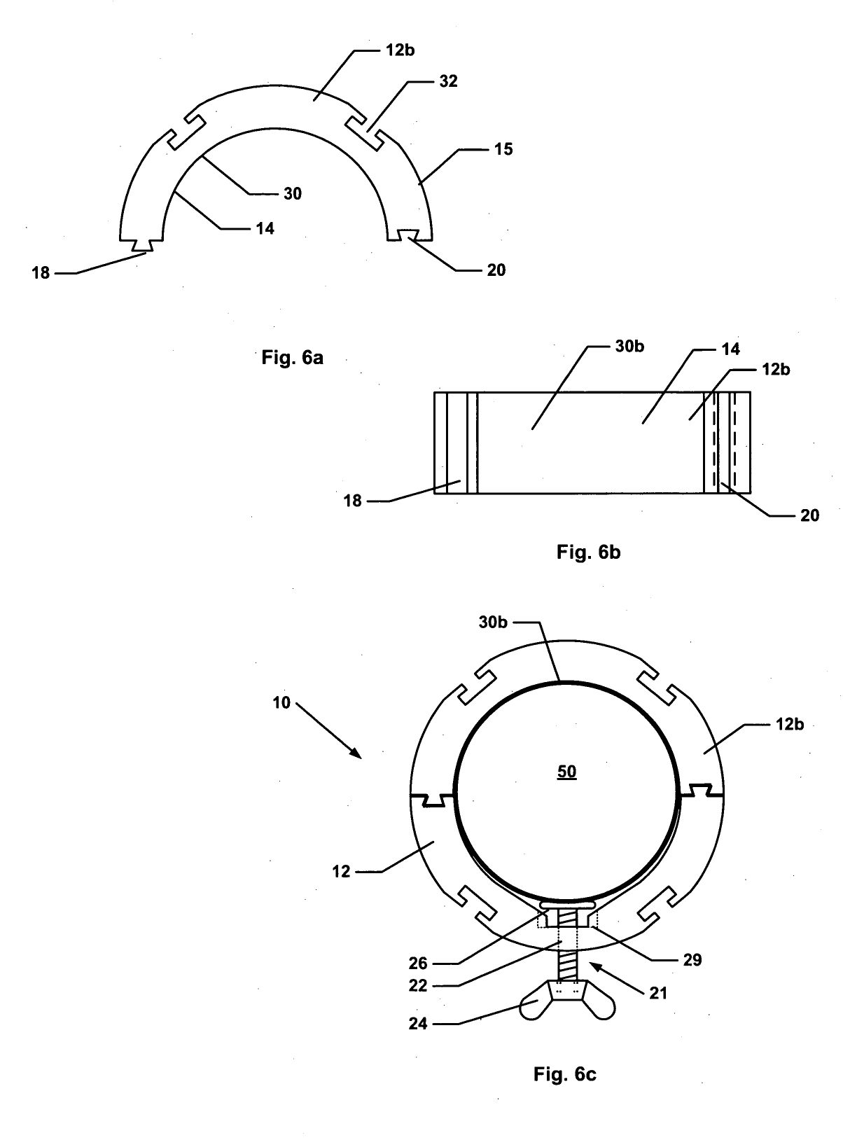

FIGS. 6a and 6b illustrate the interior construction of a third type of clamp portion 12b in accordance with one or more embodiments the present invention. Therein, inner surface 14 and bearing surface 30b are identical and substantially match the outer radius of pole 50. Therein, pole 50 is then biased bearingly against surface 30 as shown in FIG. 6c.

In a further embodiment, note illustrated, more than one clamp portion 12 have a securing means. For example, both clamp portions 12 may include a thumbscrew 24 that may each be operated to position and secure clamp 10 on pole 50. Thus, inner surface 14 in both clamp portions 12 may be configured to have any suitable shape that does not interfere with pole 50.

Returning to FIGS. 1 and 2, clamp portions 12 comprises an outer surface 15 interrupted by a plurality of spaced-apart outer channels 32, each having an opening 36 disposed in outer surface 15. Each outer channel 32 is configured to have, in cross-section, a substantially rectangular cavity closed at least partially to the exterior by a pair of walls 34 formed in the outer surface 15 and defining opening 26. Outer surface 15 in a region 15a in the vicinity of outer channels 32 comprises a substantially planar surface. Region 15a extends beyond the sidewalls of outer channel 32 so that attachment 60 may be biased to clamp 10 and bear against the clamp in region 15a with no play.

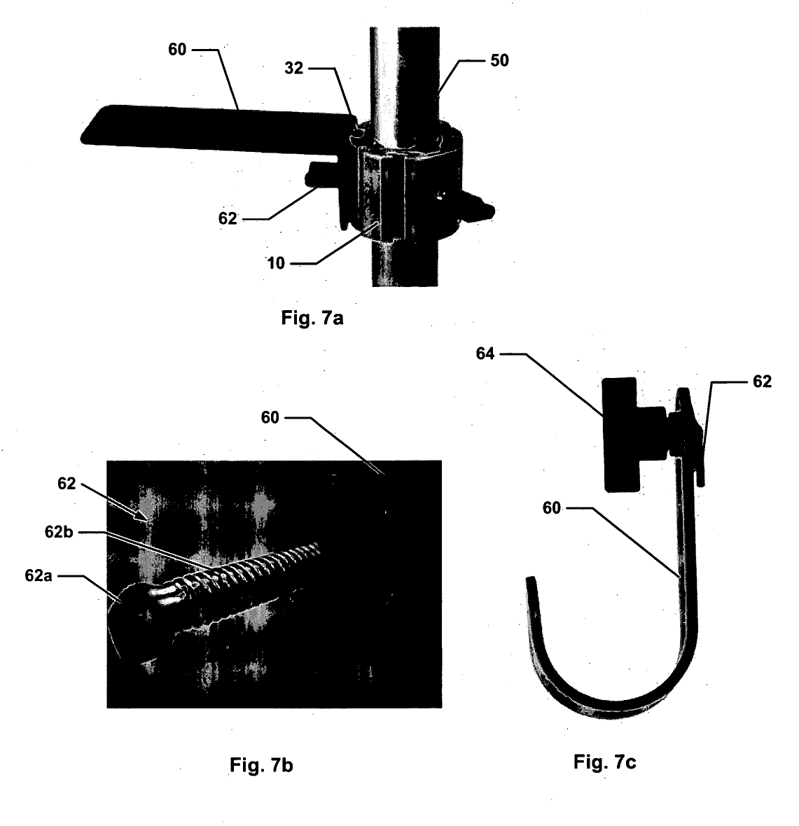

FIG. 7a is an elevational view of attachment 60 attached to or biased to clamp 10 in accordance with one or more embodiments of the present invention. Attachment 60 may be any suitable tool to display or show products and or information or aid therein. Using a connector 62, the attachment is removably attachable to or removably biasable to clamp 10 so that the user may exchange attachments or use the available display to maximum efficiency.

Attachment 60 may be a tray, arm, clip or the like and made of metal or suitable material and suitably sized for the task. Attachment 60 comprises connector 62 that attaches or biases attachment 60 to clamp 10 using one or more outer channels 32.

In one preferred embodiment, connector 62 is a screw having an L shaped head portion 62a and a threaded shank portion 62b as illustrated in FIG. 7b. Therein, the head portion 62a is sized to be received in outer channel 32 but is too large to be removed through opening 36. In contrast, the shank portion 62b is threaded and is sized so as to pass through opening 36. Connector 62 is received in attachment 60 in a suitable means, such as a threaded opening 64 that permits attachment 60 to be turned by a user and thus tightened or biased, against clamp 10 in region 15a.

In another embodiment, connector 62 may be tightened or biased against clamp 10 using a nut 66 disposed on shank 62b as shown in FIG. 7c.

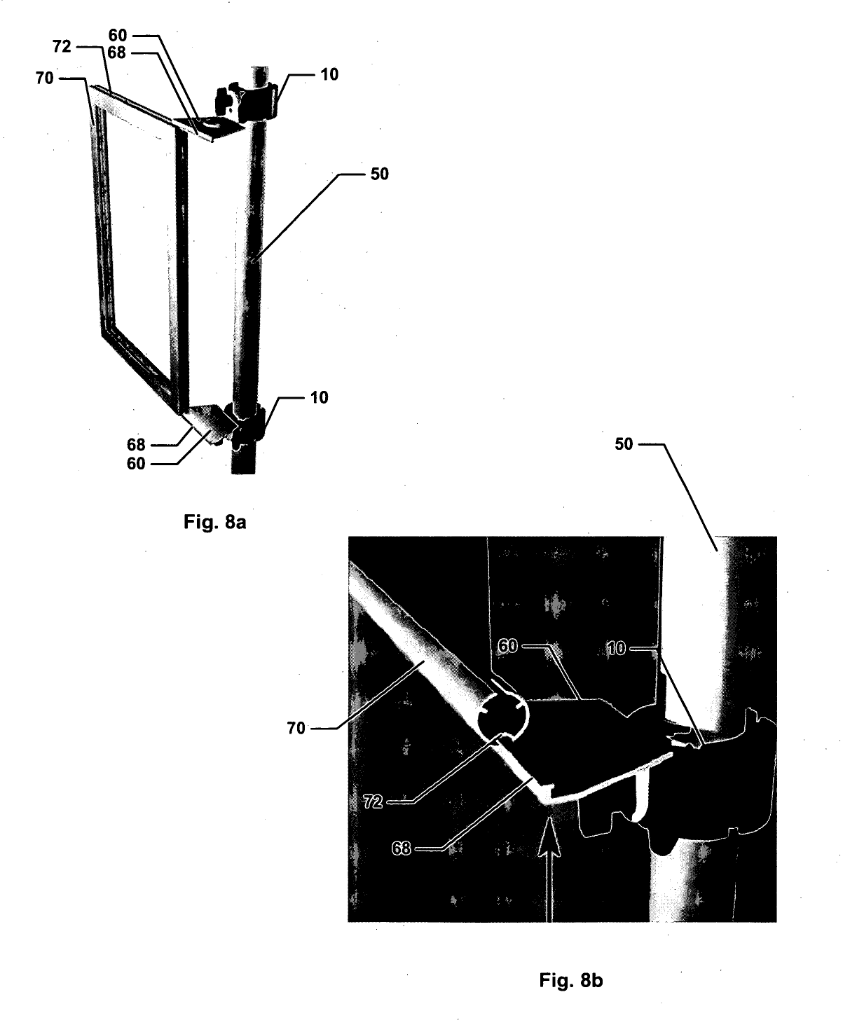

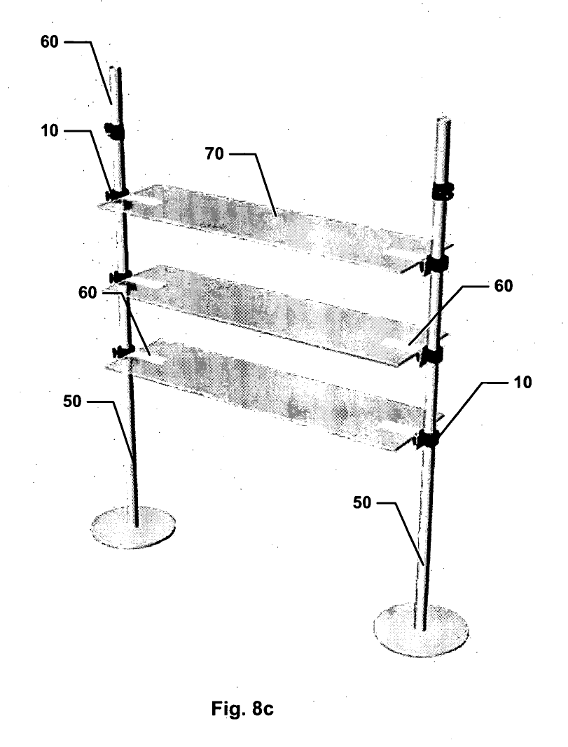

FIGS. 8a, 8b, and 8c illustrate further embodiments of the present invention wherein one or more display units 70 are supported by one or more attachments 60 in accordance with one or more embodiments of the present invention. As can be seen in FIG. 8a, attachments 60, configured as a frame bracket, may comprise an I-channel section 68 and are attached to different clamps 10 disposed on the same pole 50. A display unit 70, configured as a frame, may be advantageously connected between the attachments 60 using channel 72 to receive I-channel 68 to display a message or information deemed of interest by the user. A similar embodiment is illustrated in FIG. 8b, wherein display unit 70 is configured as a gripper and comprises a channel 72 to receive I-channel 68 of attachment 60.

As can be appreciated by FIG. 8c, a plurality of clamps 10 are disposed on more than one pole 50. Thus, it should be appreciated that one or more clamps 10 and attachments 60, herein configured as shelf brackets, may be cooperatively used to support a plurality of display units, herein configured as shelves, with a plurality of poles 50.

Of course, it should be appreciated that the present invention is illustrated with respect to two clamp portions that are engagable to clamp to circular pole 50. However, the invention should not be considered limited to such an embodiment of two clamp portions. For example, it is readily apparent that more than two (2) clamp portions may be used in accordance with the teachings of the present invention. It should also be appreciated, that the clamp portions may comprise any shape that suits engagement with pole 50.

While the present invention has been described at some length and with some particularity with respect to the described embodiments, it is not intended that it should be limited to any such particulars or embodiments or any particular embodiment, but it is to be construed with references to independent claims so as to provide the broadest possible interpretation of such claim in view of the prior art and therefore to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A clamp for maintaining a stationary position on the pole, the clamp comprising:
a plurality of clamp portion engageable with each other to form a collar around a periphery of the pole;
a positioning device disposed in one of the plurality of clamp portions, the positioning device for simultaneously compressing against the periphery of the pole and tensioning at least one of the engaged plurality of clamp portions against the pole to maintain the clamp in the stationary position on the pole.

2. The clamp of claim 1, wherein the plurality of clamp portions engage by slidingly engaging along a longitudinal axis of the pole.

3. The clamp of claim 2, wherein one of the plurality of clamp portions comprises one of a mortar and a tenon and the other of the plurality of clamp portions comprises a respective matching one of a mortar and a tenon.

4. The clamp of claim 2, wherein each of the plurality of portions comprise a mortar and a tenon.

5. The clamp of claim 1, wherein the positioning device is adjustable.

6. The clamp of claim 1, wherein one of the plurality of clamp portions comprises an outer surface comprising a channel, the channel for engaging a connector of an attachment.

7. The clamp of claim 6, wherein the outer surface comprises a wall for bearing by the attachment against the clamp.

8. The clamp of claim 3, wherein the mortar and tenon transfers a tension force from one of the plurality of clamp portions to another of the clamp portions.

9. The clamp of claim 5, wherein the positioning device comprises a threaded shank.

10. A clamp for mounting on a pole, the clamp comprising:
a plurality of clamp portion, the portions being adapted to form a collar around the pole when fitted to the pole;
a plurality of engaging portions in each clamp portions, the engaging portions of one clamp portion engaging the engaging portions of the other clamp portions so that the clamp portions when fitted to the pole are slideable with respect to a direction parallel to a longitudinal axis of the pole and transfer tension from one clamp portion to another with respect to a direction parallel to a radial direction of the pole;
a positioning device that holds the collar against the pole by pressing a distal end of the position device against the pole and forcing an inner surface of one of the clamp portions against the pole.

11. The clamp of claim 10, wherein one of the plurality of clamp portions comprises an outer urface comprising a channel, the channel for engaging a connector of an attachment.

12. The clamp of claim 11, wherein the outer surface comprises a wall for bearing by the attachment against the clamp.

13. The clamp of claim 10, wherein the clamp portions are adapted to be fitted to the pole by one user.

14. The clamp of claim 10, wherein the positioning device comprises a threaded shank.

15. A visual merchandising system comprising:
a collar comprising a plurality of collar portions, the plurality of collar portions being fit separately about a periphery of the pole and being engaged to surround the pole, a positioning device disposed in one of the plurality of collar portions, the positioning device for simultaneously compressing against the periphery of the pole and tensioning one of the plurality of collar portions against the periphery of the pole to maintain a stationary position.

16. The visual merchandising system of claim 15, further comprising an attachment for displaying objects and a connector for attaching the attachment to the collar; the connector comprising an L shaped head portion and an adjustable shank portion.

17. The visual merchandising system of claim 16, wherein one of the plurality of collar portions comprises an outer surface comprising a channel, the channel for engaging the connector and attaching the attachment.

18. The visual merchandising system of claim 17, wherein the outer surface comprises a wall for bearing by the attachment against the collar.

19. The visual merchandising system of claim 15, wherein the positioning device is adjustable.

20. The visual merchandising system of claim 15, wherein the plurality of collar portions comprise a mortar and a tenon.

21. A method of securing a clamp to a pole in visual merchandising system, the clamp comprising a first and a second clamp portion engageable with each other, and a positioning device disposed in one of the first and second clamp portions, the method comprising the steps of:
adjusting a distal end of the positioning device to be proximal to an inner surface of the respective one of the first and second clamp portions;
manipulating the inner surface of the respective one of the first and second clamp portions against a periphery of the pole;
manipulating an inner surface of the other of the first and second clamp portions against the periphery of the pole so that respective top and bottom edges of the clamp portions are one of above and below each other;
rotating one of the first and second clamp portions so that the clamp portions are engageable;
engaging the first and second clamp portions to form a collar;
adjusting the positioning device to simultaneously compress against the periphery of the pole and tension at least one of the engaged first and second clamp portions against the pole to maintain the clamp in the stationary position on the pole.
